(19) United States
(12) Patent Application Publication
(10) Pub. No.: US 2025/0004462 A1
(43) Pub. Date: Jan. 2, 2025

(54) CONTROL DEVICE

(71) Applicant: FANUC CORPORATIO, Minamitsuru-gun, Yamanashi (JP)

(72) Inventor: Dongseok KIM, Yamanashi (JP)

(21) Appl. No.: 18/688,951

(22) PCT Filed: Oct. 1, 2021
(86) PCT No.: PCT/JP2021/036507

§ 371 Date: Mar. 4, 2024

(51) Int. Cl. G05B 23/02

(52) U.S. Cl. CPC G05B 23/0264

(57) ABSTRACT

Provided is a control device that includes one or more processors and one or more memories that store instructions to be executed by the processors and/or data to be processed by the processors and controls an industrial machine, the control device comprising: a recording condition storage unit that stores one or more recording conditions relating to recording of the instructions and/or the data; a processing data specification information storage unit that stores, for each recording condition, processing data specification information specifying processing data which is of the instructions and/or the data, and is to be stored in a processing data storage unit; and a recording processing unit that records, when the recording condition is satisfied, the processing data specified by the processing data specification information corresponding to the recording condition in the processing data storage unit.

### TECHNICAL FIELD

The present invention relates to a control device.

### BACKGROUND ART

For example, in order to examine a cause of a failure in an industrial machine such as a machine tool or a robot upon occurrence of such a failure, a technique of recording log information such as a key operation history, an alarm issuance history, and a specific signal state history to analyze the cause of the failure has been known for a control device that controls the industrial machine. For example, see Patent Documents 1 and 2.

In this case, when a problem is caused in operation of the industrial machine and a cause of such a problem is examined, a worker acquires the log information until occurrence of the failure to analyze various histories in chronological order. In this manner, the cause of the failure is estimated from operation, a signal state, and an alarm issuance state upon occurrence of the failure.

### CITATION LIST

### Patent Document

Patent Document 1: Japanese Unexamined Patent Application, Publication No. 2005-4270
Patent Document 2: Japanese Unexamined Patent Application, Publication No. 2007-272545

### DISCLOSURE OF THE INVENTION

### Problems to be Solved by the Invention

Control devices that control the industrial machines are incorporated into the industrial machines (e.g., a machine tool) together with I/O equipment, an industrial PC (IPC), a motor, etc. by a machine builder.

The industrial machines are production goods, and for this reason, need to be promptly recovered upon occurrence of a failure. However, as industrial machines become more multi-functional and sophisticated, they become more complex, and there is a tendency for the occurrence of failures for which it is difficult to promptly identify the cause. For example, the failures that occur include a failure with low reproducibility and a failure with a low frequency of occurrence. Here, the failure with the low reproducibility includes, for example, a failure depending on the state of connection of the I/O equipment, the IPC, the motor, etc. and a failure (e.g., a failure caused during actual machining) reproduced only in an installation state on a production site. Moreover, the failure with the low frequency of occurrence includes, for example, a failure (e.g., a failure caused depending on timing/between a plurality of tasks) and a failure caused only when a complicated internal condition is satisfied.

It is difficult to reproduce the phenomenon of such a failure, and for this reason, examination on an existing machine on site may be required to promptly recover the machine.

For example, in order to perform the examination on the existing machine on site, examination software is created at a development base such as a laboratory of a machine builder, and a worker visits a site to load the examination software into the existing machine and execute the examination software therein. However, in this case, even if the examination software needs to be created again, the worker cannot flexibly handle this situation because the development base and the site are physically apart from each other. Moreover, in some cases, it takes considerable steps/time to perform the examination on site. This may interfere with prompt recovery.

For example, in a case where the examination is performed on the existing machine on site using a general-purpose debugging device, the worker needs to additionally attach the debugging device to the control device already incorporated into the existing machine. This leads to a problem that maintainability is poor. In a case where the environment around the existing machine is a bad environment such as a high temperature/mist, the debugging device cannot withstand such environment. Moreover, the debugging device has data collection limitations such as a limitation that sampling can be performed only under a simple condition and a limitation that operation in sampling cannot be changed.

For these reasons, it is desirable to be able to flexibly examine the cause of failures on existing machines on site.

### Means for Solving the Problems

One aspect of a control device of the present disclosure is a control device that includes one or more processors and one or more memories for storing an instruction to be executed by the one or more processors and/or data to be processed by the one or more processors, and controls an industrial machine. The control device includes a recording condition storage unit configured to store one or more recording conditions regarding recording of the instruction and/or the data, a processing data specifying information storage unit configured to store, for each of the one or more recording conditions, processing data specifying information for specifying processing data to be stored in a processing data storage unit from the instruction and/or the data, and a recording processing unit configured to record, when the one or more recording conditions are satisfied, the processing data specified by the processing data specifying information corresponding to the one or more recording conditions in the processing data storage unit.

### Effects of the Invention

According to one aspect, a cause of a failure can be flexibly examined on an existing machine on site.

### BRIEF DESCRIPTION OF THE DRAWINGS

FIG. 1 is a functional block diagram showing a functional configuration example of an examination system according to one embodiment;

FIG. 2 is a diagram showing one example of decompression in a local memory;

FIG. 3 is a diagram showing one example of the configuration of a storage unit;

FIG. 4 is a flowchart for describing processing data collection processing of a numerical control device;

FIG. 5 is a flowchart for describing examination program execution processing of Step S7 in a case of performing sampling only when a condition is satisfied based on plural pieces of data (setting a complicated condition);

FIG. 6 is a flowchart for describing the examination program execution processing of Step S7 in a case of tracing a current task stack and collecting a caller address (advanced data collection); and

FIG. 7 is a flowchart for describing the examination program execution processing of Step S7 in a case of standing by until an instruction is given from the outside (customizing operation in sampling to temporary stop).

### PREFERRED MODE FOR CARRYING OUT THE INVENTION

A numerical control device will be described as an example of a control device with reference to a specific embodiment of the control device. Note that the present invention is not limited to the numerical control device and is also applicable, for example, to a robot control device that controls an industrial robot and includes one or more processors. Moreover, the present invention is also applicable to a control device that controls an arbitrary industrial machine and includes one or more processors. Here, the industrial robot includes, for example, various machines such as a machine tool, an industrial robot, a service robot, a forge rolling machine, and an injection molding machine.

### One Embodiment

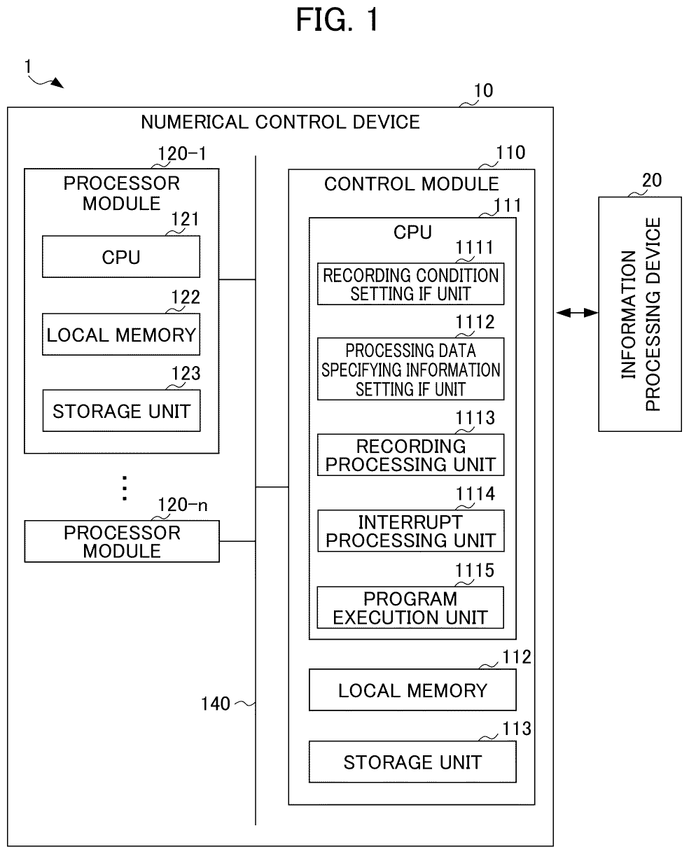

FIG. 1 is a functional block diagram showing a functional configuration example of an examination system according to one embodiment.

As shown in FIG. 1, an examination system 1 has a numerical control device 10 and an information processing device 20 as external equipment.

The numerical control device 10 and the information processing device 20 may be connected to each other via a not-shown network such as a local area network (LAN) or the Internet. In this case, the numerical control device 10 and the information processing device 20 include not-shown communication units for communicating with each other via such connection. Alternatively, the numerical control device 10 and the information processing device 20 may be directly connected to each other via a not-shown connection interface.

Note that the numerical control device 10 is connected to one information processing device 20, but may be connected to a plurality of information processing devices 20 as described later.

### <Information Processing Device 20>

The information processing device 20 is, for example, a computer or a tablet terminal, and examines a cause of a failure in the numerical control device 10 as described later.

Specifically, for example, the information processing device 20 generates a later-described recording condition regarding recording of data on the numerical control device 10 for the examination of the cause of the failure based on user's input operation via an input device (not shown) included in the information processing device 20, such as a keyboard or a touch panel, and sets the generated recording condition to the numerical control device 10. Moreover, the information processing device 20 generates later-described processing data specifying information for specifying data on the numerical control device 10, which is to be recorded according to the recording condition, based on user's input operation via the input device (not shown) of the information processing device 20, and sets the generated processing data specifying information to the numerical control device 10. Further, the information processing device 20 creates and compiles, based on user's input operation via the input device (not shown) of the information processing device 20, an examination program for acquiring the data specified by the processing data specifying information from the numerical control device 10 when the recording condition is satisfied, and loads the executable examination program into the later-described numerical control device 10.

### <Numerical Control Device 10>

The numerical control device 10 is a numerical control device well-known by those skilled in the art, and for example, generates an operation instruction based on a machining program acquired from a not-shown CAD/CAM device and transmits the generated operation instruction to a machine tool (not shown). In this manner, the numerical control device 10 controls operation of the not-shown machine tool. Note that in a case where the not-shown machine tool is, for example, a robot, the numerical control device 10 may be a robot control device.

As shown in FIG. 1, the numerical control device 10 has a control module 110 and n processor modules 120-1 to 120-n. The control module 110 and the processor modules 120-1 to 120-n are communicably connected to each other via a bus 140.

The control module 110 has a CPU 111 and a local memory 112. The CPU 111 has a recording condition setting interface (IF) unit 1111, a processing data specifying information setting interface (IF) unit 1112, a recording processing unit 1113, an interrupt processing unit 1114, and a program execution unit 1115. Each of the processor modules 120-1 to 120-n has a CPU 121 and a local memory 122.

Hereinafter, in a case where the processor modules 120-1 to 120-n do not need to be distinguished from each other, these modules will also be collectively referred to as a “processor module(s) 120”.

### <Processor Module 120>

The processor module 120 has the CPU 121, the local memory 122, and a storage unit 123.

For example, in a case of executing an application program for performing axis control, the CPU 121 may control a main axis included in a machine tool (not shown) and three axes of an X-axis, a Y-axis, and a Z-axis or five axes of an X-axis, a Y-axis, a Z-axis, an A-axis, and a B-axis for changing the position and inclination of a table. That is, the processor module 120 operates as an axis control module.

In a case of executing an application program for performing display control, the CPU 121 may control an indication on a display device of the numerical control device 10. That is, the processor module 120 operates as a display control module. In a case of executing an application program for performing peripheral equipment control, the CPU 121 may control peripheral equipment arranged at the periphery of a machine tool (not shown). That is, the processor module 120 operates as a peripheral equipment control module.

The local memory 122 is, for example, a random access memory (RAM), and the application program to be executed by the CPU 121 is loaded into the local memory 122.

The storage unit 123 is, for example, a read only memory (ROM), and the application program to be executed for the axis control, etc. by the CPU 121, data to be processed by the CPU 121, etc. are stored in the storage unit 123.

### <Control Module 110>

The control module 110 is a module that controls the entirety of the numerical control device 10, and has the CPU 111, the local memory 112, and a storage unit 113.

### <Local Memory 112>

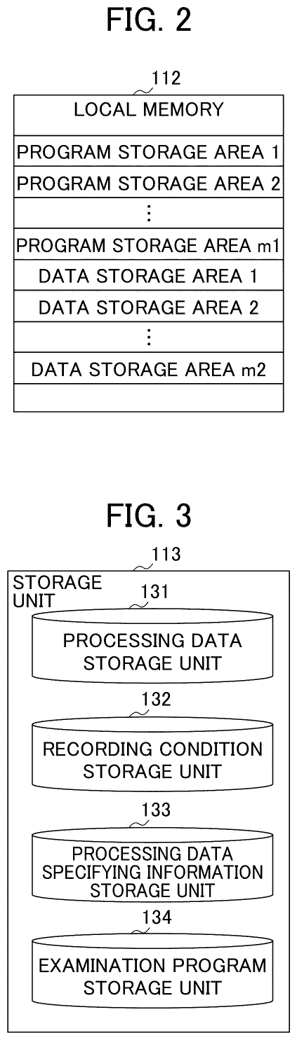

The local memory 112 includes, for example, a RAM. As described later, in a case where the CPU 111 reads the application program which is a group of a plurality of programs saved in the storage unit 113, loads the application program into the local memory 112, and executes the application program therein, the plurality of programs is decompressed in program storage areas 1 to m1 in the local memory 112, as shown in FIG. 2. Moreover, in the local memory 112, an instruction of each of the plurality of programs, data to be processed, etc. are saved in data storage areas 1 to m2. Note that m1 and m2 are integers of 2 or more.

### <Storage Unit 113>

The storage unit 113 is a memory such as a ROM. The storage unit 113 may save an instruction to be executed by the CPU 111, data to be processed by the CPU 111, etc. together with a system program and the application program. As shown in FIG. 3, the storage unit 113 includes a processing data storage unit 131, a recording condition storage unit 132, a processing data specifying information storage unit 133, and an examination program storage unit 134.

For example, as described later, when any of the recording conditions stored in the recording condition storage unit 132 is satisfied, the processing data storage unit 131 stores at least one piece of processing data specified by the processing data specifying information corresponding to the satisfied recording condition and stored in the processing data specifying information storage unit 133, such as internal information on the CPU 111 and the CPU 121 of the processor module 120, data stored in the local memory 112 and the local memory 122 of the processor module 120, instructions to be executed by the CPU 111 and the CPU 121 of the processor module 120, or addresses to which these instructions are saved.

The recording condition storage unit 132 receives, from the information processing device 20, one or more recording conditions regarding recording of the instructions to be executed by the CPU 111 and the CPU 121 of the processor module 120 and/or the data stored in the local memory 112 and the local memory 122 of the processor module 120 into the processing data storage unit 131, and saves these recording conditions. Note that the recording condition may be generated based on user's input operation via the input device (not shown) included in the numerical control device 10, such as a keyboard or a touch panel, and may be saved in the recording condition storage unit 132.

The processing data specifying information storage unit 133 receives, from the information processing device 20, the processing data specifying information for setting the processing data to be stored in the processing data storage unit 131 for each recording condition, and saves such information. Note that the processing data specifying information may be generated based on user's input operation via the input device (not shown) of the numerical control device 10, and may be saved in the processing data specifying information storage unit 133.

The examination program storage unit 134 receives, from the information processing device 20, the executable examination program to be executed for examining the cause of the failure in the numerical control device 10 when the recording condition is satisfied, and saves such a program. Note that the examination program may be generated and compiled based on user's input operation via the input device (not shown) of the numerical control device 10, and may be saved in the examination program storage unit 134.

### <CPU 111>

The CPU 111 is a processor that controls the numerical control device 10 as a whole. The CPU 111 loads the system program and the application program saved in the storage unit 113 into the local memory 112, and controls the entirety of the numerical control device 10 according to the system program and the application program. In this manner, as shown in FIG. 1, the CPU 111 is configured to implement the functions of the recording condition setting IF unit 1111, the processing data specifying information setting IF unit 1112, the recording processing unit 1113, the interrupt processing unit 1114, and the program execution unit 1115.

In a case where the application program is a group of programs forming a software system including, e.g., a program (e.g., a source code name “safty_function.src”) responsible for a safety function of the numerical control device 10, the CPU 111 loads, into the local memory 112, an application program (group of programs) converted into an executable instruction from, e.g., safty_function.src by compiling, and accordingly, these programs are decompressed in the program storage areas 1 to m1 of the local memory 112 by the system program. For example, the executable instruction generated from the source code of safty_function.src may be decompressed in the program storage area 1 of the local memory 112. An executable instruction generated from another source code included in the group of programs may be decompressed in the program storage area i (i is an integer of 2 to m1) of the local memory 112.

In this manner, the CPU 111 can simultaneously execute the instructions each saved in the program storage areas 1 to m1 of the local memory 112.

For example, the recording condition setting IF unit 1111 displays a recording condition setting interface (IF) for setting the recording condition to be stored in the recording condition storage unit 132 on a display device (not shown) included in the information processing device 20, such as a liquid crystal display (LCD). Via the recording condition setting IF displayed based on user's input operation, the recording condition setting IF unit 1111 sets, as the recording condition, a condition for setting a state to determine whether to record the above-described processing data when any state occurs in the numerical control device 10. The recording condition setting IF unit 1111 stores, in the recording condition storage unit 132, the recording condition set by the information processing device 20.

For example, as the recording condition, a condition such as “when an instruction saved to an address ‘0x0100 0000’ of the local memory 112 of the control module 110 (or the local memory 122 of the processor module 120) is executed”, “when the CPU 111 of the control module 110 (or the CPU 121 of the processor module 120) executes a branch instruction”, or “when data saved to an address ‘0x0200 0000’ of the local memory 112 of the control module 110 (or the local memory 122 of the processor module 120) is read” may be set.

The processing data specifying information setting IF unit 1112 displays, for example, on the display device (not shown) of the information processing device 20, a processing data specifying information interface (IF) for setting the processing data specifying information for specifying the processing data (e.g., CPU general-purpose register, CPU internal information such as a CPU timer value, the value of accessed data, memory data such as the value of data saved to a specific address, binary data on an executed instruction, or an address to which such an instruction is saved) to be stored in the processing data storage unit 131 for each recording condition. The processing data specifying information setting IF unit 1112 sets, via the processing data specifying information setting IF displayed based on user's input operation, the processing data specifying information for specifying the processing data to be stored in the above-described processing data specifying information storage unit 133 when the above-described recording condition is satisfied during the processing in the numerical control device 10. The processing data specifying information setting IF unit 1112 stores, in the processing data specifying information storage unit 133, the processing data specifying information set by the information processing device 20.

For example, in the case of the above-described recording condition of “when the instruction saved to the address ‘0x0100 0000’ of the local memory 112 of the control module 110 (or the local memory 122 of the processor module 120) is executed”, “acquiring data (CPU internal information) from ‘0’th to ‘31’th general-purpose registers of the CPU 111 of the control module 110 (or the CPU 121 of the processor module 120)” may be set as the processing data specifying information. In the case of the recording condition of “when the CPU 111 of the control module 110 (or the CPU 121 of the processor module 120) executes the branch instruction”, “acquiring an address (program counter) to which the executed instruction has been saved as an executed instruction saving area and acquiring a timer value (CPU internal information) in the CPU” may be set as the processing data specifying information. In the case of the recording condition of “when the data saved to the address ‘0x0200 0000’ of the local memory 112 of the control module 110 (or the local memory 122 of the processor module 120) is read”, “acquiring a timer value (CPU internal information) in the CPU 111 (or the CPU 121) and acquiring data of 0x10 bytes from the address ‘0x0200 0000’ of the local memory 112 (or the local memory 122)” may be set as the processing data specifying information.

For example, when any of the recording conditions stored in the recording condition storage unit 132 is satisfied, the recording processing unit 1113 records, in the processing data storage unit 131, the processing data specified by the processing data specifying information corresponding to the satisfied recording condition.

For example, the interrupt processing unit 1114 executes interrupt processing when the recording condition is satisfied, and interrupts the processing executed before execution of the interrupt processing to perform context switch, e.g., for saving a register and setting a stack pointer. Thereafter, in a case where the interrupt processing unit 1114 receives a data recording completion notification indicating completion of recording of the processing data by the recording processing unit 1113, the interrupt processing unit 1114 ends the interrupt processing by performing context switch, e.g., for restoring the register and the stack pointer. After completion of the interrupt processing, the interrupt processing unit 1114 resumes the original processing executed before execution of the interrupt processing.

For example, when the recording condition is satisfied, when the recording condition is satisfied, the program execution unit 1115 executes the examination program loaded into the examination program storage unit 134 to record, in the processing data storage unit 131, the processing data specified by the processing data specifying information corresponding to such a recording condition. In this manner, the program execution unit 1115 can (a) perform sampling only when a condition is satisfied based on plural pieces of data (set a complicated condition), (b) can trace a current task stack and collecting a caller address (advanced data collection), or (c) can stand by until an instruction is given from the outside (customize operation in sampling to temporary stop).

Note that the operations (a) to (c) of the program execution unit 1115 based on the examination program will be described later as examination program execution processing.

### <Processing Data Collection Processing of Numerical Control Device 10>

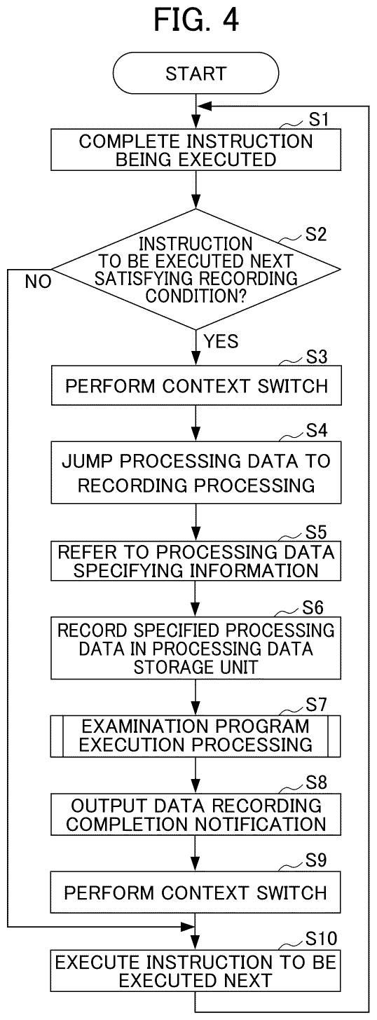

Next, the flow of processing data collection processing of the numerical control device 10 will be described with reference to FIG. 4.

FIG. 4 is a flowchart for describing the processing data collection processing of the numerical control device 10. The flow described here is repeatedly executed while the CPU 111 (or the CPU 121 of the processor module 120) is executing an instruction.

In Step S1, the CPU 111 (or the CPU 121 of the processor module 120) completes an instruction executed currently (previously).

In Step S2, the recording processing unit 1113 determines whether or not an instruction to be executed subsequently to the instruction completed in Step S1 satisfies any of the recording conditions stored in the recording condition storage unit 132. In a case where the instruction to be executed next satisfies the recording condition, the processing proceeds to Step S3. On the other hand, in a case where the instruction to be executed next does not satisfy the recording condition, the processing proceeds to Step S10.

In Step S3, the interrupt processing unit 1114 executes the interrupt processing, and interrupts the currently-executed processing to perform context switch, e.g., for saving a register and setting a stack pointer.

In Step S4, the recording processing unit 1113 jumps to processing data recording processing.

In Step S5, the recording processing unit 1113 refers to the processing data specifying information corresponding to the recording condition.

In Step S6, the recording processing unit 1113 records, in the processing data storage unit 131, the processing data specified by the processing data specifying information.

In Step S7, the program execution unit 1115 executes the examination program loaded into the examination program storage unit 134 to perform the examination program execution processing. Note that a detailed flow of the examination program execution processing will be described later.

In Step S8, the recording processing unit 1113 outputs a processing data recording completion notification in a case where recording of the processing data has been completed.

In Step S9, in a case where the interrupt processing unit 1114 has received the data recording completion notification output in Step S8, the interrupt processing unit 1114 performs context switch, e.g., for restoring the register and the stack pointer and completes the interrupt processing. After completion of the interrupt processing, the interrupt processing unit 1114 resumes the original processing executed before execution of the interrupt processing.

In Step S10, the CPU 111 (or the CPU 121 of the processor module 120) executes a next instruction. Then, the numerical control device 10 returns to Step S1.

Next, the examination program execution processing of Step S7 of FIG. 4 in each case of the above-described operations (a) to (c) will be described.

Note that in description below, a case where the CPU 111 of the control module 110 executes an instruction will be described. However, a case where the CPU 121 of the processor module 120 executes an instruction is similar to the case of the CPU 111 of the control module 110.

(a) Case of Performing Sampling Only when Condition is Satisfied Based on Plural Pieces of Data (Setting Complicated Condition)

Specifically, for example, a case where a cause of a failure when the processing in the program storage area 1 saving the program responsible for the safety function of the numerical control device 10 is significantly delayed, real-time control cannot be performed in time, and the system is stopped is sampled (examined) will be described as the examination program execution processing. Note that the numerical control device 10 may execute the examination program execution processing for sampling (examining) a cause of a failure in a case other than the case where the processing in the program storage area 1 saving the program responsible for the safety function is significantly delayed. In this case, the examination program may be preferably created by the information processing device 20 for sampling (examining) the cause of such a failure.

In a case where the processing in the program storage area 1 is significantly delayed, it is necessary to check how much time the processing in the program storage area 1 saving the program responsible for the safety function requires and check which part of the processing in the program storage area 1 is particularly delayed as compared to that in a normal case. Thus, the examination program is created in the information processing device 20 and loaded into the examination program storage unit 134 such that sampling (examination) is performed to (1) record a clock time when instruction execution by the CPU 111 of the control module 110 branches into an instruction (function) included in the program storage area 1 from the program storage area i (i≠1) and the address of the instruction of the branch destination, (2) record a clock time when each branch instruction is executed by the CPU 111 of the control module 110 in the program storage area 1 and the address of the instruction of the branch destination, and (3) record a clock time when instruction execution by the CPU 111 of the control module 110 transitions from the instruction (function) in the program storage area 1 to another program storage area i and the address of the instruction of the branch destination (transition destination).

In this manner, in the examination program execution processing, the examination program is executed so that the total time of execution of the instruction (program) in the program storage area 1 by the CPU 111 of the control module 110 can be measured from the clock time recorded in (1) and the clock time recorded in (3). Moreover, in the examination program execution processing, the flow of each type of processing executed in the program storage area 1 by the CPU 111 and the processing time thereof can be acquired based on the clock time and the address recorded in (2). Then, in the examination program execution processing, it can be determined whether or not the measured total time of execution in the program storage area 1 has significantly increased as compared to that in the normal case. Moreover, in the examination program execution processing, for example, in a case where it has been found that crosscheck processing which is the safety function in the program storage area 1 is often invoked and takes significantly-great time, such crosscheck processing can be identified as the cause of the failure based on the acquired flow of each type of processing and the acquired processing time thereof.

Note that the cases of the program storage areas 2 to m1 are similar to the case of the program storage area 1, and therefore, description thereof will be omitted.

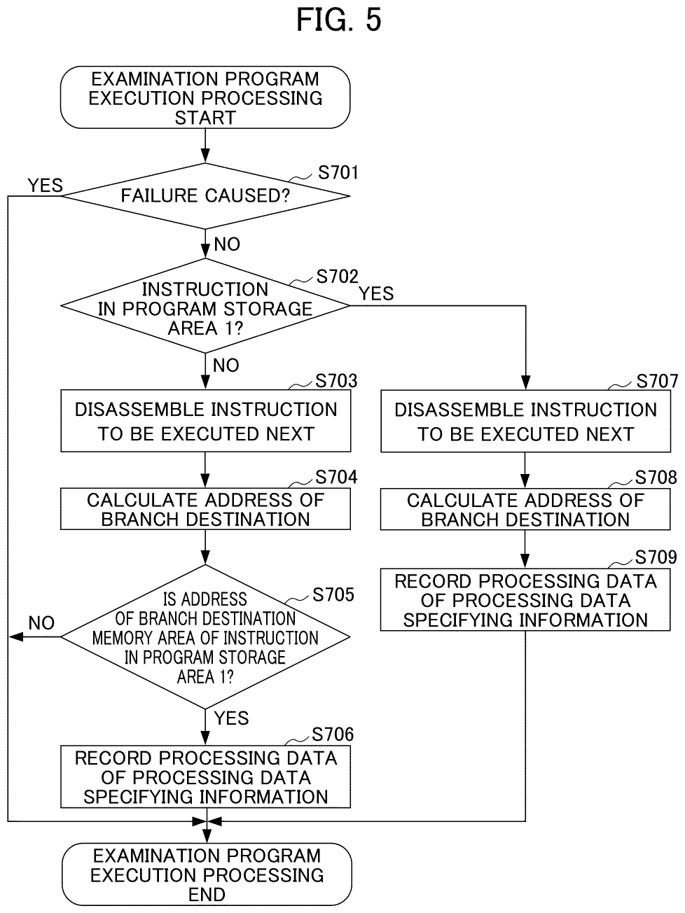

FIG. 5 is a flowchart for describing the examination program execution processing of Step S7 in the case of performing sampling only when the condition is satisfied based on the plural pieces of data (setting the complicated condition).

In this case, the recording condition is set to “execution of a branch instruction” by the recording condition setting IF unit 1111 based on user's input operation on the information processing device 20. That is, the instruction to be executed next in Step S2 of FIG. 4 is the branch instruction. Moreover, the processing data specifying information is set to “a clock time (timer counter value in the CPU) when the branch instruction is executed and the address of the instruction of the branch destination” by the processing data specifying information setting IF unit 1112 based on user's input operation on the information processing device 20.

Note that the branch instruction is often given, and for this reason, if the processing data is recorded every time the above-described recording condition is satisfied, the number of pieces of processing data to be recorded is great. Thus, a large-capacity memory is required for saving the processing data, and the processing is delayed because the processing data is recorded in every branch instruction. This leads to execution of the processing in a flow different from that upon occurrence of the failure. As a result, there is a problem that such a failure cannot be reproduced.

In order to prevent such a problem, the program execution unit 1115 executes the examination program when the recording condition is satisfied, and performs the examination program execution processing of FIG. 5.

In Step S701, the program execution unit 1115 checks, based on the examination program, data set upon occurrence of the failure (e.g., the presence or absence of issuance of an alarm and stop of an operating system), and determines whether or not the failure is caused. In order to record the processing data until immediately before occurrence of the failure, in a case where the failure is caused, the program execution unit 1115 ends the examination program execution processing and skips the processing data recording processing. Then, the processing proceeds to Step S8 of FIG. 4. Then, in Step S9 of FIG. 4, the interrupt processing unit 1114 ends the interrupt processing, and the processing returns to the original processing.

With this configuration, the numerical control device 10 can avoid collection of extra information after occurrence of the failure, and the failure targeted for sampling (examination) can be reproduced without the need for preparing the large-capacity processing data storage unit 131.

On the other hand, in a case where the failure is not caused, the processing proceeds to Step S702.

In Step S702, the program execution unit 1115 checks, based on the examination program, the address to which the instruction to be executed next in Step S2 of FIG. 4 has been saved, and determines whether or not such an instruction is an instruction (branch instruction) in the program storage area 1. In a case where the instruction is the instruction (branch instruction) in the program storage area 1, the processing proceeds to Step S707. On the other hand, in a case where the instruction is not the instruction (branch instruction) in the program storage area 1, the processing proceeds to Step S703.

In Step S703, the program execution unit 1115 disassembles the instruction (branch instruction) to be executed next in Step S2 of FIG. 4 based on the examination program.

In Step S704, the program execution unit 1115 calculates, based on the examination program, the address of the branch destination of the instruction (branch instruction) to be executed next in Step S2 of FIG. 4. Note that the address of the branch destination may be calculated using a well-known technique (for example, the branch destination may be acquired from a CPU link register in a case of a branch instruction using the link register, or the address of the branch destination may be extracted from a specific bit of the instruction (as one example, 16th to 32th bits of a 32-bit instruction are checked) in a case where the address of the branch destination is described in the binary data of the instruction).

In Step S705, the program execution unit 1115 determines, based on the examination program, whether or not the address of the branch destination calculated in Step S704 is a memory area saving the instruction in the program storage area 1. In a case where the address is the memory area saving the instruction in the program storage area 1, the processing proceeds to Step S706.

On the other hand, in a case where the address is not the memory area saving the instruction in the program storage area 1, the program execution unit 1115 ends the examination program execution processing and skips the processing data recording processing. The processing proceeds to Step S8 of FIG. 4. Then, in Step S9 of FIG. 4, the interrupt processing unit 1114 ends the interrupt processing, and the processing returns to the original processing.

In Step S706, the recording processing unit 1113 records, in the processing data storage unit 131, the processing data (i.e., the clock time of branch into the processing in the program storage area 1 and the address of the instruction of the branch destination) specified by the processing data specifying information. Then, the program execution unit 1115 ends the examination program execution processing, and the processing returns to Step S8 of FIG. 4. In Step S9 of FIG. 4, the interrupt processing unit 1114 ends the interrupt processing, and the processing returns to the original processing.

In Step S707, the program execution unit 1115 disassembles, based on the examination program, the instruction (branch instruction) to be executed next in Step S2 of FIG. 4.

In Step S708, the program execution unit 1115 calculates, based on the examination program, the address of the branch destination of the instruction (branch instruction) to be executed next in Step S2 of FIG. 4.

In Step S709, the recording processing unit 1113 records, in the processing data storage unit 131, the processing data (i.e., the clock time of each branch in the program storage area 1, the address of the instruction of the branch destination, the clock time of transition from the instruction in the program storage area 1 to another program storage area i, and the address of the instruction of the branch destination) specified by the processing data specifying information. Then, the program execution unit 1115 ends the examination program execution processing, and the processing returns to Step S8 of FIG. 4. In Step S9 of FIG. 4, the interrupt processing unit 1114 ends the interrupt processing, and the processing returns to the original processing.

### (b) Case of Tracing Current Task Stack and Collecting Caller Address (Advanced Data Collection)

Specifically, for example, a case where when the processing in the program storage area 1 saving the program responsible for the safety function of the numerical control device 10 is significantly delayed, the real-time processing cannot be performed in time, and the system is stopped, the delayed data crosscheck processing as the safety function is particularly sampled (examined) in detail will be described as the examination program execution processing.

For example, in order to grasp the flow of processing, the caller of a function including an instruction to which the processing data has been recorded in response may be checked. That is, for example, in a case where the processing data is collected in response to an instruction included in a function called from a plurality of functions, sampling (examination) is performed only in a case where an instruction is called from a desired function, and a caller is sequentially traced. In this manner, the flow of processing until the instruction is executed can be grasped. Thus, using these pieces of information, it can be checked how to execute the processing having caused the failure, and the cause of the failure can be identified.

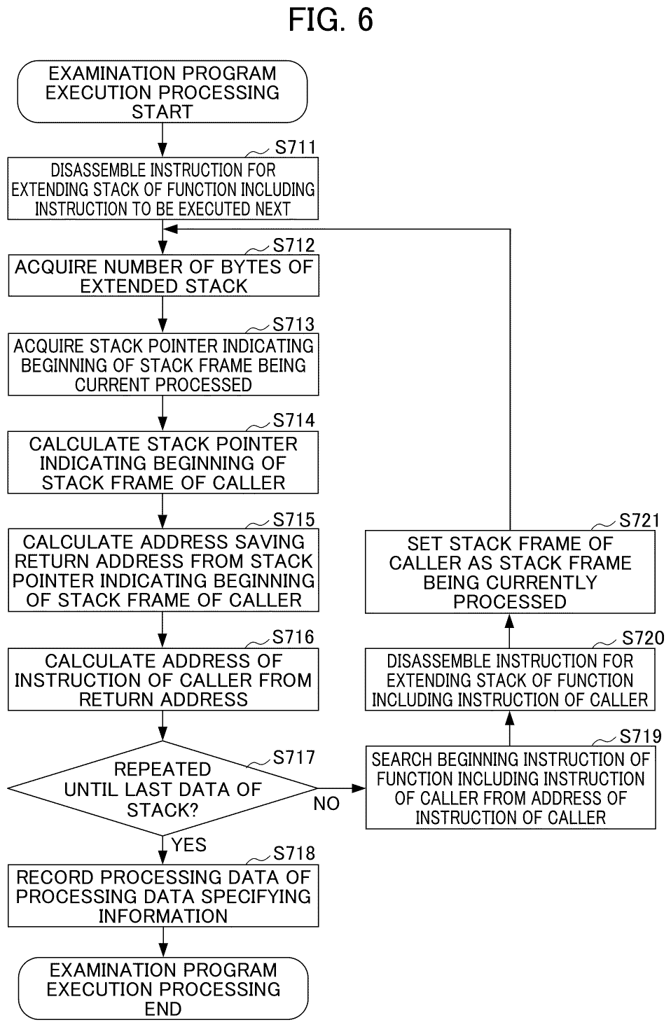

FIG. 6 is a flowchart for describing the examination program execution processing of Step S7 in the case of tracing the current task stack and collecting the caller address (advanced data collection).

In this case, the recording condition is set, based on user's input operation on the information processing device 20, to “executing an instruction included in a function for performing the data crosscheck processing as the safety function in the program storage area 1” by the recording condition setting IF unit 1111. Moreover, the processing data specifying information is set, based on user's input operation on the information processing device 20, to “the address of the executed instruction, a clock time (timer counter value in the CPU) when the instruction is executed, and information on an argument when the function for performing the crosscheck processing is called” by the processing data specifying information setting IF unit 1112. Note that the argument information can be acquired, for example, from data in the general-purpose register of the CPU 111 of the control module 110 and stack information saved in the local memory 112.

Thus, the information processing device 20 creates an examination program for collecting a return address saved in the stack in order to trace the current task stack to collect the caller address (advanced data collection). The information processing device 20 compiles the created examination program, and loads the executable examination program into the examination program storage unit 134 of the numerical control device 10. The program execution unit 1115 executes the examination program when the recording condition is satisfied, thereby performing the examination program execution processing of FIG. 6.

In Step S711, the program execution unit 1115 disassembles, based on the examination program, an instruction for extending a beginning stack of a function including the instruction to be executed next in Step S2 of FIG. 4.

In Step S712, the program execution unit 1115 acquires, based on the examination program, the number of bytes of the extended stack (for example, m bytes) (m is an integer of 1 or more). Note that the number of bytes of the extended stack may be acquired, for example, by extraction from a specific bit of the instruction for extending the stack (as one example, checking 16th to 32th bits of a 32-bit instruction).

In Step S713, the program execution unit 1115 acquires, based on the examination program, a stack pointer indicating the beginning of a stack frame being currently processed. Note that the stack pointer indicating the beginning of the stack frame being currently processed can be acquired from, e.g., the register of the CPU 111 of the control module 110 upon first execution of Step S713 and from Step S721 described later upon second and subsequent executions of Step S713.

In Step S714, the program execution unit 1115 calculates, based on the examination program, a stack point indicating the beginning of a stack frame of a caller obtained by rewinding the stack pointer indicating the beginning of the stack frame being currently processed by the number of bytes acquired in Step S712.

In Step S715, the program execution unit 1115 calculates, based on the examination program, an address to which a return address has been saved from the stack pointer indicating the beginning of the stack frame of the caller calculated in Step S714. Note that the address to which the return address has been saved can be calculated, for example, from the stack pointer indicating the beginning of the stack frame of the caller (as one example, the address is calculated by adding offset p bytes of the return-address saving address to the address indicated by the stack pointer of the beginning of the stack frame of the caller).

In Step S716, the program execution unit 1115 acquires, based on the examination program, the return address from the address calculated in Step S715, and calculates the address of the instruction of the caller. Note that the address of the instruction of the caller can be acquired, for example, by calculation (as one example, in a case where the lengths of all instructions to be executed by the CPU 111 of the control module 110 are fixed to 32 bits, the address is calculated by subtracting 4 bytes (32 bits) from the return address) of one instruction address before the return address.

In Step S717, the program execution unit 1115 determines, based on the examination program, whether or not the processing has been repeated until the last data of the stack. In a case where the processing has been repeated until the last data of the stack, the processing proceeds to Step S718. On the other hand, in a case where the processing is not repeated until the last data of the stack, the processing proceeds to Step S719.

In Step S718, the recording processing unit 1113 records, in the processing data storage unit 131, the address of the instruction of the caller calculated in Step S719 together with the processing data specified by the processing data specifying information. Then, the program execution unit 1115 ends the examination program execution processing, and the processing returns to Step S8 of FIG. 4. In Step S9 of FIG. 4, the interrupt processing unit 1114 ends the interrupt processing, and the processing returns to the original processing.

In Step S719, the program execution unit 1115 searches, based on the examination program, a beginning instruction of a function including the instruction of the caller calculated in Step S716 from the address of such an instruction.

In Step S720, the program execution unit 1115 disassembles, based on the examination program, the instruction for extending the stack of the function including the instruction of the caller.

In Step S721, the program execution unit 1115 sets, as the stack frame being currently processed, the stack frame indicated by the stack pointer of the beginning of the stack frame of the caller calculated in Step S714 executed previously. Moreover, a stack pointer indicated by the stack frame newly set and being currently processed is held. Then, the processing returns to Step S712.

In a case where the stack itself is saved, a capacity of several hundreds of bytes to several thousands of bytes is required. However, with the above-described configuration, the numerical control device 10 can record significant information with less data capacity because the numerical control device 10 saves only the address of the instruction of the caller.

The way to extend the stack, the return address saving area in the stack, etc. depend on a compiler/hardware. In a case where the hardware or the compiler has been changed, only the examination program is changed according to the changed hardware or compiler so that the caller can be examined regardless of the hardware or the compiler. Thus, the numerical control device 10 can continuously provide the same maintenance function only by preparation of a function of executing the examination program even in a case where the hardware or the compiler has been changed.

(c) Case of Standing by Until Instruction is Given from Outside (Customizing Operation in Sampling to Temporary Stop)

Specifically, for example, a case where when the processing in the program storage area 1 saving the program responsible for the safety function of the numerical control device 10 is significantly delayed, the real-time control cannot be made in time, and the system is stopped, processing of substituting an improper argument has been found in the processing of a function including an instruction of a caller in the data crosscheck processing as the safety function will be described as the examination program execution processing.

In this case, for example, the numerical control device 10 temporarily stops execution of the examination program at the time of substitution of the improper argument in the processing of the function including the instruction of the caller, and checks the saved data such as the internal information in the local memory and the CPU at this point. With this configuration, the numerical control device 10 can examine, for example, from which data the improper argument has been calculated in more detail.

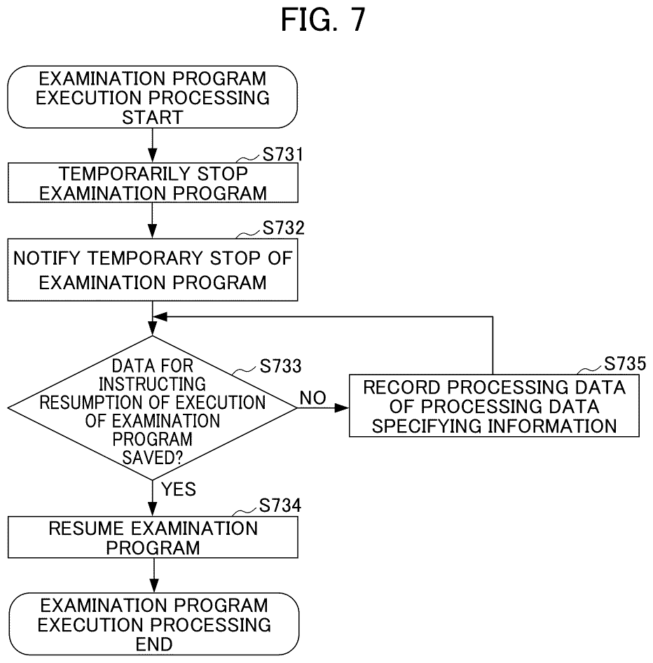

FIG. 7 is a flowchart for describing the examination program execution processing of Step S7 in the case of standing by until the instruction is given from the outside (customizing operation in sampling to temporary stop).

In this case, based on user's input operation on the information processing device 20, the recording condition is set to “executing the processing of substituting the improper argument” by the recording condition setting IF unit 1111. Moreover, based on user's input operation on the information processing device 20, the processing data specifying information is set to “not specified” by the processing data specifying information setting IF unit 1112.

Then, the program execution unit 1115 executes the examination program when the recording condition is satisfied, and performs the examination program execution processing of FIG. 7.

In Step S731, the program execution unit 1115 temporarily stops the examination program because the recording condition has been satisfied in Step S2 of FIG. 4.

In Step S732, the program execution unit 1115 notifies the information processing device 20 of the temporary stop of the examination program. The information processing device 20 displays, for example, the received notification on the display device (not shown) included in the information processing device 20, such as an LCD.

In Step S733, the program execution unit 1115 determines whether or not data for instructing resumption of execution of the examination program is saved in a control variable in a memory area settable from the information processing device 20, such as the storage unit 113 or the local memory 112. In a case where the data for instructing resumption of execution of the examination program is saved, the processing proceeds to Step S734. On the other hand, in a case where the data for instructing resumption of execution of the examination program is not saved, the processing proceeds to Step S735.

In Step S734, the program execution unit 1115 resumes the examination program using the control variable. Then, the program execution unit 1115 notifies the information processing device 20 of the resumption of the examination program. The program execution unit 1115 ends the examination program execution processing, and the processing returns to Step S8 of FIG. 4. In Step S9 of FIG. 4, the interrupt processing unit 1114 ends the interrupt processing, and the processing returns to the original processing.

In Step S735, in a case where the control variable instructs the output of the processing data specifying information and the processing data, the program execution unit 1115 makes a copy of the processing data specified by the processing data specifying information and stores the copy in the memory area referable from the information processing device 20, such as the storage unit 113 or the local memory 112. Then, the processing returns to Step S733.

With this configuration, even in a case where the examination program is temporarily stopped because the recording condition has been satisfied, the information processing device 20 sets, based on user's input operation, the data for instructing resumption of execution of the examination program to the control variable of the numerical control device 10 so that the examination program can be resumed.

Moreover, even in a case where the examination program is temporarily stopped, the information processing device 20 sets, based on user's input operation, the output of the processing data specifying information and the processing data to the control variable of the numerical control device 10 so that desired processing data can be acquired and examination can be performed in more detail.

In the examination program execution processing of FIG. 7, in a case where a request for executing real-time processing (e.g., processing which needs to be executed in certain control cycles) is given, the program execution unit 1115 may temporarily interrupt, in order to temporarily stop the examination program, a task A in which the examination program is executed and cause the task A to transition to a task B for executing the real-time processing. Then, after the end of the task B, the program execution unit 1115 returns to the task A so that the examination can be continuously performed.

With the above-described configuration, the information processing device 20 sets the recording condition and the processing data specifying information according to examination contents, and the examination program corresponding to the examination contents is loaded from the information processing device 20. Accordingly, the numerical control device 10 of one embodiment can flexibly examine the cause of the failure on an existing machine on site.

Moreover, the numerical control device 10 can remotely examine the existing machine, and can acquire the CPU internal information/executed instruction. Thus, a source code level failure can be examined while source code confidentiality is maintained.

Further, the numerical control device 10 can perform debugging by the numerical control device alone without degradation of maintainability/environment resistance.

In addition, the numerical control device 10 can set a complicated sampling condition/operation by executing the examination program, and can implement advanced failure examination without hardware.

One embodiment has been described above, but the numerical control device 10 is not limited to the above-described embodiment and includes changes, modifications, etc. within a scope in which the object can be achieved.

### Modification 1

In one embodiment, the numerical control device 10 samples (examines), as the examination program execution processing, the cause of the failure in a case where the processing in the program storage area 1 saving the program responsible for the safety function of the numerical control device 10 is significantly delayed, but the present invention is not limited thereto. For example, the numerical control device 10 may execute examination program execution processing of sampling (examining) a cause of a failure other than the case where the processing in the program storage area 1 saving the program responsible for the safety function is significantly delayed.

### Modification 2

For example, in the above-described embodiment, the CPU 111 of the control module 110 collects the instructions to be executed by the CPU 111 of the control module 110 and the CPU 121 of the processor module 120 and the data to be processed thereby, but the present invention is not limited thereto. For example, the CPU 121 of the processor module 120-i may collect instructions to be executed by the CPU 111 of the control module 110 and the CPU 121 of the processor module 120 and data to be processed thereby.

In this case, the CPU 121 of the processor module 120-i may be configured to read the operating system and the application program saved in the storage unit 123, load the operating system and the application program into the local memory 122, and implement the functions of the recording condition setting IF unit 1111, the processing data specifying information setting IF unit 1112, the recording processing unit 1113, the interrupt processing unit 1114, and the program execution unit 1115 according to the operating system and the application program. In a case where the CPU 121 reads the application program which is the group of the plurality of programs saved in the storage unit 123, loads the application program into the local memory 122, and executes the application program therein, the plurality of programs may be decompressed in the program storage areas 1 to m1 in the local memory 122 of the processor module 120-i, as shown in FIG. 2.

With this configuration, the CPU 121 of the processor module 120-i can collect the processing data from a program storage area k saving a program responsible for the axis control processing or the image display processing causing the failure.

### Modification 3

For example, in the above-described embodiment, the processing data storage unit 131, the recording condition storage unit 132, the processing data specifying information storage unit 133, and the examination program storage unit 134 are arranged in the storage unit 113 of the control module 110, but the present invention is not limited thereto. For example, the processing data storage unit 131, the recording condition storage unit 132, the processing data specifying information storage unit 133, and the examination program storage unit 134 may be arranged in a storage device connected via the bus 140, which is different from the control module 110 and the processor module 120. Alternatively, the processing data storage unit 131, the recording condition storage unit 132, the processing data specifying information storage unit 133, and the examination program storage unit 134 may be arranged in, e.g., a data server connected to the numerical control device 10 via a network.

Alternatively, in a case where the CPU 111 of the control module 110 (and the CPU 121 of the processor module 120) is a multi-core CPU, the processing data storage unit 131, the recording condition storage unit 132, the processing data specifying information storage unit 133, and the examination program storage unit 134 may be arranged for each core.

With this configuration, different conditions/processing data specifying information can be set to each core in one CPU 111 (or the CPU 121), and the storage unit 113 can independently collect the processing data.

Note that each function of the numerical control device 10 according to one embodiment may be implemented by hardware, software, or a combination thereof. Here, implementation by the software means implementation by reading and execution of a program by a computer.

The program can be saved using various types of non-transitory computer readable media and be supplied to the computer. The non-transitory computer readable media include various types of tangible storage media. Examples of the non-transitory computer readable media include magnetic recording media (e.g., a flexible disk, a magnetic tape, and a hard disk drive), magnetic optical recording media (e.g., a magnetic optical disk), a CD-read only memory (CD-ROM), a CD-R, a CD-R/W, and semiconductor memories (e.g., a mask ROM, a programmable ROM (PROM), an erasable PROM (EPROM), a flash ROM, and a RAM). The program may be supplied to the computer by means of various types of transitory computer readable media. Examples of the transitory computer readable media include an electric signal, an optical signal, and an electromagnetic wave. The transitory computer readable medium can supply the program to the computer via a wired communication path such as an electric wire or an optical fiber or a wireless communication path.

Note that the steps of describing the program recorded in the recording medium include not only processing performed in chronological order, but also processing executed in parallel or separately.

In other words, the control device of the present disclosure may include various embodiments having the following configurations.
(1) The numerical control device 10 of the present disclosure is a control device including one or more CPUs 111, 121 and one or more local memories 112, 122 for storing an instruction to be executed by the CPUs 111, 121 and/or data to be processed by the CPUs 111, 121 and controlling an industrial machine. The control device includes a recording condition storage unit 132 configured to store one or more recording conditions regarding recording of the instruction and/or the data, a processing data specifying information storage unit 133 configured to store, for each of the one or more recording conditions, processing data specifying information for specifying processing data to be stored in a processing data storage unit 131 from the instruction and/or the data, and a recording processing unit 1113 configured to record, when the one or more recording conditions are satisfied, the processing data specified by the processing data specifying information corresponding to the one or more recording conditions in the processing data storage unit 131.

According to the numerical control device 10, a cause of a failure can be flexibly examined on an existing machine on site.
(2) In the numerical control device 10 according to (2), the processing data may include at least one of internal information on the CPUs 111, 121, the data stored in the one or more local memories 112, 122, the instruction, or an instruction saving area of the instruction.

With this configuration, the numerical control device 10 can examine the failure with favorable accuracy.
(3) The numerical control device 10 according to (1) or (2) may further include a recording condition setting interface unit 1111 configured to set the one or more recording conditions.

With this configuration, the numerical control device 10 can change the setting of the one or more recording conditions as necessary, and can more flexibly examine the failure.
(4) The numerical control device 10 according to any one of (1) to (3) may further include a processing data specifying information setting interface unit 1112 configured to set the processing data specifying information.

With this configuration, the numerical control device 10 can specify and save only required data, and can record significant information with less data capacity and processing load.
(5) The numerical control device 10 according to any one of (1) to (4) may further include an examination program storage unit 134 configured to store an executable examination program to be executed when the one or more recording conditions are satisfied, and a program execution unit 1115 configured to execute the examination program when the one or more recording conditions are satisfied.

With this configuration, the numerical control device 10 can examine the failure in more detail.
(6) In the numerical control device 10 according to any one of (1) to (4), the one or more recording conditions and/or the processing data specifying information may be settable and/or referable from an information processing device 20.

With this configuration, the numerical control device 10 can more flexibly examine the failure.
(7) In the numerical control device 10 according to (5), at least any one of the one or more recording conditions, the processing data specifying information, or the examination program may be settable and/or referable from an information processing device 20.

With this configuration, the numerical control device 10 can provide advantageous effects similar to those of (6).
(8) In the numerical control device 10 according to any one of (1) to (7), the processing data may be referable from the information processing device 20.

With this configuration, a user can examine the failure in more detail.
(9) In the numerical control device 10 according to any one of (1) to (8), the processing data may be output to the information processing device 20.

With this configuration, the numerical control device 10 can provide advantageous effects similar to those of (8).
(10) The numerical control device 10 according to any one of (1) to (9) may further include an interrupt processing unit 1114 configured to execute interrupt processing when the one or more recording conditions are satisfied and resumes, after completion of the interrupt processing, original processing executed before execution of the interrupt processing.

With this configuration, the numerical control device 10 can record the processing data in the state at the time of occurrence of the failure.

### EXPLANATION OF REFERENCE NUMERALS

1 Examination System
10 Numerical Control Device
110 Control Module
111 CPU
1111 Recording Condition Setting IF Unit
1112 Processing Data Specifying Information Setting IF Unit
1113 Recording Processing Unit
1114 Interrupt Processing Unit
1115 Program Execution Unit
112 Local Memory
113 Storage Unit
131 Processing Data Storage Unit
132 Recording Condition Storage Unit
133 Processing Data Specifying Information Storage Unit
134 Examination Program Storage Unit
120-1 to 120-n Processor Module
121 CPU
122 Local Memory
123 Storage Unit
140 Bus
20 Information Processing Device

1. A control device that includes one or more processors and one or more memories for storing an instruction to be executed by the one or more processors and/or data to be processed by the one or more processors, and controls an industrial machine, comprising:
a recording condition storage unit configured to store one or more recording conditions regarding recording of the instruction and/or the data;
a processing data specifying information storage unit configured to store, for each of the one or more recording conditions, processing data specifying information for specifying processing data to be stored in a processing data storage unit from the instruction and/or the data; and
a recording processing unit configured to record, when the one or more recording conditions are satisfied, the processing data specified by the processing data specifying information corresponding to the one or more recording conditions in the processing data storage unit.

2. The control device according to claim 1, wherein the processing data includes at least one of internal information on the one or more processors, the data stored in the one or more memories, the instruction, or an instruction saving area of the instruction.

3. The control device according to claim 1, further comprising a recording condition setting interface unit configured to set the one or more recording conditions.

4. The control device according to claim 1, further comprising a processing data specifying information setting interface unit configured to set the processing data specifying information.

5. The control device according to claim 1, further comprising:
an examination program storage unit configured to store an executable examination program to be executed when the one or more recording conditions are satisfied; and
a program execution unit configured to execute the examination program when the one or more recording conditions are satisfied.

6. The control device according to claim 1, wherein the one or more recording conditions and/or the processing data specifying information are settable and/or referable from external equipment.

7. The control device according to claim 5, wherein at least any one of the one or more recording conditions, the processing data specifying information, or the examination program is settable and/or referable from external equipment.

8. The control device according to claim 1, wherein the processing data is referable from external equipment.

9. The control device according to claim 1, wherein the processing data is output to external equipment.

10. The control device according to claim 1, further comprising: an interrupt processing unit configured to execute interrupt processing when the one or more recording conditions are satisfied and resumes, after completion of the interrupt processing, original processing executed before execution of the interrupt processing.
